(19) United States
(12) Patent Application Publication
(10) Pub. No.: US 2025/0380084 A1
(43) Pub. Date: Dec. 11, 2025

(54) COOPERATIVE AUDIO FREQUENCY REPRODUCTION FOR SPEAKER DEVICES

(71) Applicant: Microsoft Technology Licensing, LLC, Redmond, WA (US)

(72) Inventors: Mengxi YU, Sammamish, WA (US); Jian ZOU, Shanghai (CN); Huipeng YANG, Beijing (CN)

(73) Assignee: Microsoft Technology Licensing, LLC, Redmond, WA (US)

(21) Appl. No.: 18/736,220

(22) Filed: Jun. 6, 2024

(51) Int. Cl. H04R 3/04; H04R 3/02; H04R 3/12; H04R 29/00

(52) U.S. Cl. CPC H04R 3/04; H04R 3/02; H04R 3/12; H04R 29/002; H04R 2430/01

(57) ABSTRACT

Techniques and solutions are provided for improving teleconference audio. For a first speaker device, one or more frequencies are determined where the first speaker device provides poor audio quality, such as due to vibration or echo distortion. One or more attenuation values are determined for the first speaker device to compensate for the poor audio quality. One or more values for increasing the gain of the one or more frequencies at a second speaker device are determined, where the one or more values are selected to compensation for attenuation of the one or more frequencies at the first speaker device. The one or more frequency attenuation values and the one or more frequency gain increase values are applied to audio rendered at the first and second speaker devices during a teleconference.

### FIELD

The present disclosure generally relates to audio processing. In one embodiment, the present disclosure provides for selectively balancing frequencies in multi-speaker teleconferencing, or in unified communications or remote collaboration.

### BACKGROUND

Teleconferencing continues to maintain, or even increase, its importance. For example, as businesses often operate in multiple locations, and have employees in those locations, as well as, increasingly, employees working remotely, in person meetings may not be feasible.

Unfortunately, audio quality remains an ongoing concern. In the context of teleconferencing or multi-speaker audio systems, echo distortion refers to the undesirable phenomenon where the original audio signal from a speaker is reflected back and captured by microphones in the same environment, resulting in an audible echo or feedback loop. This echo is perceived as a delayed and attenuated repetition of the original audio, which can degrade the overall sound quality and intelligibility of the communication. Echo distortion can occur due to acoustic reflections within the room, mechanical coupling between speakers and microphones, or signal processing artifacts in the audio system. It can interfere with speech clarity, cause listener fatigue, and disrupt effective communication during teleconferences or meetings. Thus, minimizing echo distortion is important for ensuring clear and natural-sounding audio reproduction in teleconferencing environments.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are provided for improving teleconference audio. For a first speaker device, one or more frequencies are determined where the first speaker device provides poor audio quality, such as due to vibration or echo distortion. One or more attenuation values are determined for the first speaker device to compensate for the poor audio quality. One or more values for increasing the gain of the one or more frequencies at a second speaker device are determined, where the one or more values are selected to compensation for attenuation of the one or more frequencies at the first speaker device. The one or more frequency attenuation values and the one or more frequency gain increase values are applied to audio rendered at the first and second speaker devices during a teleconference.

In one aspect, the present disclosure provides a process for improving audio quality by determining frequency attenuation and frequency gain increases for first and second speaker devices. A first audio configuration signal is generated. The first audio configuration signal is sent to be rendered by a first speaker device. First audio output generated by the first speaker device in response to the first audio configuration signal is received. Digital processing is performed on the first audio output to generate at least a first value for at least a first audio quality metric. Using the at least a first value for the at least a first audio quality metric, at least a first value for attenuating at least a first audio frequency is determined. The at least a first value is stored in association with an identifier of the first speaker device. At least a first gain compensation is determined for a second speaker device for the at least a first audio frequency, where a value of the at least a first gain compensation is determined using the at least a first value for attenuating the at least a first audio frequency.

In another aspect, the present disclosure provides a process for improving audio quality during audio rendering using frequency attenuation and frequency gain increase values for first and second speaker devices. The process begins with the receipt of a request to initiate a teleconferencing software application. Usage of a first speaker device and a second speaker device by the teleconferencing application is determined. Retrieval of at least a first value for attenuating the at least a first frequency at the first speaker device is performed. At least a second value for increasing a gain of the at least a first frequency at the second speaker device is retrieved, where the at least a second value compensates at least in part for attenuating the at least a first frequency at the first speaker device. Audio for a teleconference is rendered, which includes receiving an audio signal. At least a first frequency in the audio signal is attenuated and the attenuated audio signal is sent to the first speaker device. Finally, the gain of the at least a first frequency in the audio signal is increased and a gain-increased audio signal, having the second value applied to the at least a first frequency, is sent to the second speaker device.

In a further aspect, the present disclosure provides a process for improving audio quality by determining frequency attenuation and frequency gain increase values for first and second speaker devices that are applied to audio during a teleconference. The process begins by determining a first value for attenuating at least a first frequency of an audio signal. The A second value is determined for increasing a gain of the at least a first frequency of the audio signal that compensates for attenuating the at least a first frequency of the audio signal.

A request to initiate a teleconferencing software application is received. The audio signal is rendered at a first speaker device while applying the first value. The audio signal is rendered at a second speaker device while applying the first value concurrently with rendering the audio signal at the first speaker device. This application of the first value and the second value provides improved audio quality by reducing vibration or distortion at the first speaker device.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1) is a diagram illustrating an example conference environment in which disclosed techniques can be implemented.

FIG. 2) is a flowchart of a process for configuring speaker devices to provide improved cooperative audio frequency reproduction.

FIG. 3 is a flowchart of a process for using configuration information for speaker devices during setup of teleconferencing equipment to provide improved cooperative audio frequency reproduction.

FIG. 4 provides example python code for attenuating or increasing the gain of frequencies in an audio signal.

FIG. 5 is a flowchart of an example process for determining whether speaker devices for a conference computing system are appropriately configured for improved cooperative audio frequency reproduction.

FIG. 6A is a flowchart of a process for improving audio quality by determining frequency attenuation and frequency gain increases for first and second speaker devices.

FIG. 6B is a flowchart of a process for improving audio quality during audio rendering using frequency attenuation and frequency gain increase values for first and second speaker devices.

FIG. 6C is a flowchart of a process for improving audio quality by determining frequency attenuation and frequency gain increase values for first and second speaker devices that are applied to audio during a teleconference.

FIG. 7 is a diagram of an example computing system in which some described embodiments can be implemented.

FIG. 8 is an example cloud computing environment that can be used in conjunction with the technologies described herein.

### DETAILED DESCRIPTION

### Example 3)—Overview

Teleconferencing continues to maintain, or even increase, its importance. For example, as businesses often operate in multiple locations, and have employees in those locations, as well as, increasingly, employees working remotely, in person meetings may not be feasible.

Unfortunately, audio quality remains an ongoing concern. In the context of teleconferencing or multi-speaker audio systems, echo distortion refers to the undesirable phenomenon where the original audio signal from a speaker is reflected back and captured by microphones in the same environment, resulting in an audible echo or feedback loop. This echo is perceived as a delayed and attenuated repetition of the original audio, which can degrade the overall sound quality and intelligibility of the communication. Echo distortion can occur due to acoustic reflections within the room, mechanical coupling between speakers and microphones, or signal processing artifacts in the audio system. It can interfere with speech clarity, cause listener fatigue, and disrupt effective communication during teleconferences or meetings. Thus, minimizing echo distortion is important for ensuring clear and natural-sounding audio reproduction in teleconferencing environments.

The present disclosure provides techniques and solutions for balancing audio content frequencies between two or more speaker devices. A speaker device refers to any standalone audio output device equipped with at least one speaker or driver designed to produce sound within a room or space. Speaker devices include but are not limited to stereo speakers, soundbars, built-in speakers integrated into televisions, computers, mobile phones, and conference phones. These devices are intended to emit audio for shared listening experiences, facilitating communication, entertainment, or other audio-related activities within a room or enclosed environment. Speaker devices may vary in size, form factor, audio quality, and functionality, but they serve the purpose of delivering audible sound output to listeners in a room or space. Speaker devices do not include personal listening devices, such as headphones, earphones, or ear buds.

A speaker device can include one or more speaker elements, such as speaker drivers. Speaker drivers are the individual transducer units within a speaker device responsible for converting electrical signals into audible sound waves. Speaker devices may contain multiple drivers, each specialized for reproducing a specific range of frequencies. For example, woofers are large drivers designed to reproduce low-frequency (bass) sounds, while tweeters are smaller drivers optimized for high-frequency (treble) sounds. In addition to woofers and tweeters, speaker devices may also include midrange drivers, subwoofers, or other specialized drivers to achieve a desired frequency response and sound quality. These drivers work together to produce a full range of audio frequencies.

Balancing audio refers to balancing frequencies or frequency bands between speaker devices. In a conference call scenario, the audio transmission typically revolves around frequency bands used for speech communication. These frequency bands encompass various ranges crucial for conveying speech intelligibility and clarity. That is, distortion or low gain in one of these ranges can make conference audio more difficult for participants to understand.

Low frequencies, from 0 Hz to approximately 250 Hz, contribute fundamental speech elements, including vocal fry (also known as glottalization) and certain consonant sounds such as “m” and “n.” Despite their lower prominence compared to higher frequencies, low frequencies add warmth and fullness to vocal tones.

The bulk of speech sounds occur in the mid frequencies, roughly spanning from approximately 250 Hz to approximately 2000 Hz. This range is important for conveying speech intelligibility and clarity, as it encompasses the fundamental components of spoken words and syllables.

High frequencies, extending from approximately 2000 Hz to approximately 8000 Hz or higher, enhance the clarity, brightness, and articulation of speech. These frequencies are used for speech elements such as sibilant sounds (e.g., “s,” “sh,” “z”) and high-pitched consonants like “t,” “k,” and “p,” which are important for speech comprehension, especially in noisy environments.

Finally, ultra-high frequencies, above 8000 Hz, offer additional detail and articulation in speech. While less critical for speech intelligibility compared to mid and high frequencies, they contribute to overall sound quality and naturalness, particularly in high-fidelity audio systems.

Conference call systems and telecommunication applications often limit audio bandwidth to optimize network resources and minimize latency. Consequently, the audio signal may undergo filtering or compression to focus on essential frequency components relevant for speech communication while minimizing data transmission requirements.

Balancing can be accomplished by adjusting the gain of particular frequencies or frequency bands for a speaker device. Gain refers to the amplification or attenuation of an audio signal. It represents the ratio of the output level to the input level of a signal and is typically expressed in decibels (dB). In simpler terms, gain controls the overall loudness or amplitude of an audio signal. Unless indicated otherwise, in the present disclosure attenuation refers to decreasing gain.

When it comes to speaker devices, gain is often associated with controlling the volume of sound produced by the speakers. However, gain and volume are not precisely the same, although they are closely related.

Volume, commonly referred to as “speaker volume,” is a perceptual attribute that describes the subjective loudness of sound as perceived by the listener. It is the result of the combination of various factors, including the amplitude of the audio signal, the gain applied by the amplifier, the efficiency of the speaker drivers, and the acoustic properties of the listening environment. Adjusting the volume control on a speaker device typically adjusts the gain of the amplifier, which in turn affects the loudness of the sound produced. Volume can be reported in various ways, such as sound pressure level (having units of decibels). Volume from different speakers can be compared using a standard of the sound pressure level a fixed distance from a speaker device, such as one meter.

In other words, gain is an adjustment applied to an audio signal, while volume refers to the perceived loudness of sound. If gain is increased uniformly, it is typically associated with an increased loudness, without (discounting limits of speaker elements of speaker devices) affecting the relative loudness of particular frequencies/frequency bands. Similarly, volume can be kept relatively constant, even though the respective gains of individual frequencies/frequency bands may be adjusted.

In the context of audio systems, gain can also be applied selectively to specific frequency bands or audio channels to achieve desired tonal balance or dynamic characteristics. This process is known as equalization (EQ) and involves boosting or cutting specific frequency ranges to adjust the overall tonal quality of the audio signal.

Granular control over gain in specific frequency bands can be achieved through parametric or graphic equalizers, which can be used to adjust the amplitude of individual frequency bands within the audio spectrum. Parametric equalizers provide precise control over frequency, gain, and bandwidth (Q factor), allowing specific frequencies to be targeted. Graphic equalizers, on the other hand, offer a set of fixed-frequency bands, each with its own gain control (in physical devices or a user interface, this may be represented as a slider).

Disclosed frequency balancing techniques operate by selectively reducing the gain of certain frequencies or frequency bands in one speaker device, and compensating for this reduction by increasing the gain of such frequencies or frequency bands in another speaker device. In some cases, the gains can be decreased at one speaker device and correspondingly increased at another speaker device, such as to maintain an overall perceived loudness of a frequency band in a listening environment. In other cases, gain can be increased by a smaller amount or by a larger amount. For example, gain may be increased less if it might cause reduced audio quality, overall or at the speaker device where the gain is increased.

Gain may be increased by more than a corresponding amount, such as if a speaker device whose gain is being increased is at a comparatively larger physical distance from the speaker device whose gain is being decreased. That is, assume that a listener is physically proximate a speaker device with a frequency band whose gain is being reduced. It may be necessary to increase the gain of the frequency band at a speaker device that is further away by more than the attenuation amount in order for the listener to compensate for the gain reduction.

As noted, a particular issue that arises in teleconferencing is echo distortion. While echo distortion can arise from a combination of different speaker devices and microphones, it can be particularly problematic when the speaker device includes a microphone that is active during a teleconference, due to the potential for acoustic feedback loops and physical proximity between the microphone and speaker components.

In such configurations, sound emitted from the speaker propagates through the air and reaches the microphone within the same device. The microphone picks up this sound, including any reflected or reverberated sound waves, and feeds it back into the speaker. This creates a feedback loop where the sound is continuously re-amplified and retransmitted, leading to the occurrence of echo distortion.

The close proximity of the microphone to the speaker exacerbates this issue, as it increases the likelihood of sound from the speaker being picked up by the microphone and fed back into the system. This can result in persistent echo artifacts that interfere with the original audio signal, causing confusion, reducing speech intelligibility, and degrading overall audio quality.

Moreover, in speaker devices where the microphone and speaker share a common housing or enclosure, mechanical coupling between the two components can further exacerbate echo distortion. Vibrations generated by the speaker can be transmitted to the microphone through the device's structure, leading to additional noise and distortion in the captured audio signal.

The vibrations generated by the speaker can occur across a broad range of frequencies, depending on the audio content being rendered. However, certain frequency bands may be more prone to causing mechanical coupling due to the resonance characteristics of the speaker device and its components.

For example, low-frequency vibrations, typically in the bass range (20 Hz to 200 Hz), can induce significant mechanical vibrations in the speaker enclosure and chassis. These low-frequency vibrations have longer wavelengths and higher energy levels, making them more likely to propagate through the device's structure and reach the microphone. As a result, low-frequency vibrations can introduce rumbling or buzzing noises in the captured audio signal, contributing to overall distortion and degradation of sound quality.

In addition to low-frequency vibrations, mid-range frequencies (200 Hz to 2000 Hz) can also contribute to mechanical coupling between the speaker and microphone components. While mid-range frequencies may not induce as much physical vibration in the speaker enclosure as low frequencies, they can still cause subtle movements or resonances that are picked up by the microphone.

High-frequency vibrations, typically in the treble range (above 2000 Hz), are less likely to induce mechanical coupling between the speaker and microphone due to their shorter wavelengths and lower energy levels. However, they can still contribute to overall noise and distortion in the audio signal if not adequately controlled.

Echo distortion compensation algorithms are designed to mitigate the effects of echo distortion in audio communication systems, particularly in scenarios where sound from a speaker is inadvertently picked up by a microphone and retransmitted back into the system. These algorithms aim to estimate and remove the echo component from the microphone signal, resulting in clearer, more intelligible audio reproduction.

Echo distortion compensation algorithms typically operate using adaptive filtering techniques, where a model of the echo path between the speaker and microphone is estimated and used to predict and subtract the echo component from the microphone signal. These algorithms continuously monitor the incoming audio signal, adaptively adjusting filter coefficients based on changes in the echo path and environmental conditions.

One common approach used in echo distortion compensation algorithms is acoustic echo cancellation (AEC), which estimates the impulse response of the acoustic echo path and uses this estimate to generate a filter that approximates the inverse of the echo path. The filtered output is then subtracted from the microphone signal to remove the echo component, leaving behind the desired speech signal.

In the presence of mechanical vibrations, echo distortion compensation algorithms may be less performant. Vibrations generated by the speaker can introduce additional noise and interference in the microphone signal, complicating the estimation and cancellation of echo distortion. These vibrations can result in non-linear distortions in the microphone signal, making it more difficult for the algorithm to accurately model and subtract the echo component.

Signal preprocessing techniques such as high-pass filtering or spectral shaping can be used to enhance the visibility of vibration-related features in the microphone signal, to facilitate removing or compensating for such vibration. Adaptive filtering techniques, such as Wiener filtering or adaptive noise cancellation, may be used to suppress background noise and enhance the detection of vibration-induced artifacts.

Machine learning algorithms, including support vector machines (SVMs), neural networks, or decision trees, are often trained on labeled datasets to automatically identify vibration signatures within the microphone signal. Feature selection methods, such as principal component analysis (PCA) or mutual information-based techniques, can be used to identify the most discriminative features for vibration detection and classification.

Adaptive thresholding techniques dynamically adjust threshold levels based on the signal's characteristics, helping to detect vibration-induced artifacts while minimizing false positives. Decision fusion strategies, such as majority voting or weighted averaging, may be employed to combine the outputs of multiple vibration detection algorithms, improving overall detection reliability.

Physics-based models of mechanical vibrations in the speaker enclosure and microphone structure can be incorporated into the algorithm to improve the accuracy of vibration estimation and compensation. Finite element analysis (FEA) or modal analysis techniques may be used to simulate the propagation of vibrations through the speaker device's structure and predict their effects on the microphone signal.

Online learning algorithms, such as online gradient descent or recursive least squares (RLS) algorithms, are often used to continuously adapt the algorithm's parameters based on real-time feedback, optimizing performance in dynamic acoustic environments. Model predictive control (MPC) techniques may be employed to predict future vibration-induced artifacts and proactively adjust the algorithm's processing parameters to minimize their impact.

However, while vibration detection and compensation techniques can help mitigate the effects of mechanical vibrations on microphone signals, they may not completely eliminate vibration-induced noise, especially in scenarios where vibrations are significant or persistent. For example, as the volume of the speaker device is increased, such as when used in a large conference room or placed further from listeners, vibrations and other issues causing degraded audio quality can increase. In such cases, it may be preferable to address the root cause of vibrations by reducing or eliminating them altogether, such as using techniques of the present disclosure, rather than relying solely on compensation techniques. As noted above, techniques that simply selectively attenuating frequencies at a particular speaker device, such as to reduce vibration, can make the resulting audio signal harder for listeners to interpret, since a full range of frequencies better ensures speech comprehension.

Disclosed techniques can include performing a setup or calibration routine for a particular speaker device or, more typically, two or more speaker devices that will be used in combination during teleconferences. An audio signal can be provided to a speaker device, such as one with an integrated microphone. The audio signal can probe different frequencies or frequency bands, and vibration or distortion, or other causes of degraded audio, can be determined in a signal captured by the microphone. If the amount of vibration or distortion in a particular frequency band exceeds a threshold, the gain of the frequency band is attenuated, such as in an audio setting of a software application. When the speaker device is used, at least with a particular software application, or type of software application, the attenuation of the setting can be applied.

Correspondingly, when a frequency band is attenuated at one speaker device, the gain of the frequency band at another speaker device can be increased compensatorily.

Frequency attenuation and gain settings can be maintained in a number of ways. For example, in one implementation, frequency attenuation or gain settings can be stored in association with a device type of a particular speaker device, such as a specific manufacturer and model, and a value calculated for one representative device can be used for multiple similar devices. However, even devices of the same manufacturer and model can exhibit variability in their speaker elements, and so frequency attenuation or gain can be stored for specific units of a particular speaker device, such as using the serial number of the device or another unique identifier assigned to the speaker device.

When another speaker device is used with an attenuated speaker device, the additional speaker device can be associated with a setting to increase its gain of frequencies attenuated in the attenuated speaker device. The additional speaker device can also be associated with configuration information, such as information about frequency gains that are acceptable for different frequencies. For example, it can be undesirable to compensate for distortion or other audio quality issues by attenuating frequencies in a first speaker device, but then introduce distortion in another speaker device. However, in some cases, it can be beneficial to increase the gain at the additional speaker device even if some distortion is introduced, such as because distortion introduced at the additional speaker device may be less problematic than distortion at the attenuated speaker device, such as when the attenuated speaker device would exhibit speaker-microphone coupling for distortion that would not be present for distortion (such as resulting from vibration) of a different speaker device.

### Example 24)—Example Conference Environment

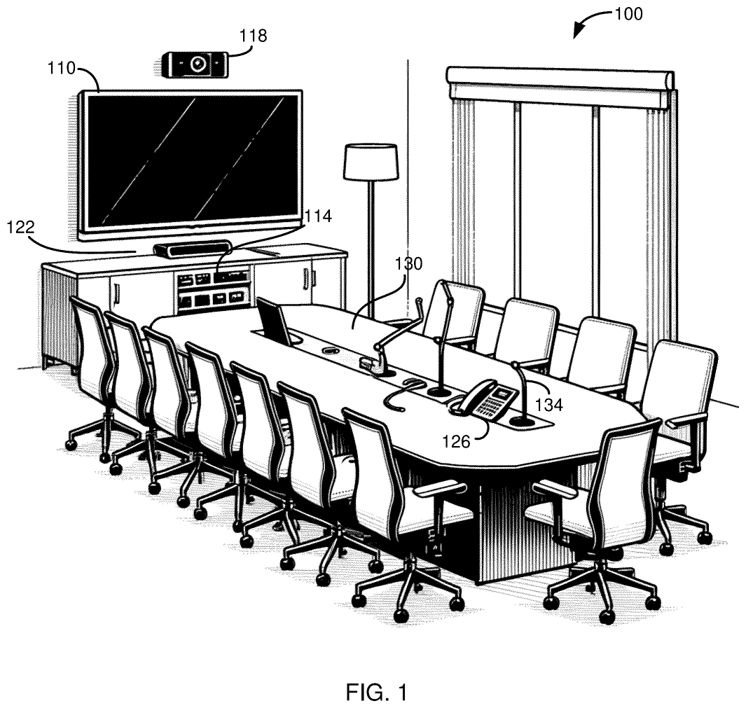

FIG. 1 illustrates an example conference environment 100. The conference environment includes a display device 110, such as a television or monitor. The display device 110, in some implementations, includes software for performing conferencing, such as audio conferencing or video conferencing. In other cases, the display device 110 is connected to a computing device 114, and the computing device performs conference operations, but displays video content on the display device.

In some cases, the display device 110 can include one or more speaker elements, in which case the display device can serve as a speaker device. The display device 110, depending on implementation, can have a microphone.

The conference environment 100 can include additional components, such as a camera 118 for capturing video from the conference environment. The conference environment 100 is also shown as including a soundbar 122, where the soundbar can include one or more speaker elements, and serves as a speaker device. In some examples, the soundbar 122 can include one or more microphones.

Disclosed techniques involve conference scenarios where there are multiple speaker devices, although in some implementations, aspects of the present disclosure can be performed with respect to a single speaker device, which is used in such a conference scenario. FIG. 1 illustrates a speakerphone 126 located on a conference table 130 of the conference environment 100. The speakerphone 126 is provided as an example of an additional speaker device, but the additional speaker device can be other types of devices, such as a speakerphone that does not include a handset as does the speakerphone 126, and the speaker can be of higher quality/larger than the speaker of the speakerphone 126.

At least one of the speaker devices in the conference environment 100 includes an integrated microphone. The conference environment 100 can include additional microphones, including microphones 134 that are not integrated into a speaker device.

In an example of the disclosed techniques, the speaker elements of the soundbar 122 and the speaker elements of the speakerphone 126 can have different characteristics. For example, the soundbar 122 may be better at reproducing low and mid-range frequencies, but may be less adept at reproducing high frequencies. In contrast, the speakerphone 126 may be better at reproducing high frequencies, but may be less adept at reproducing low, or even mid-range frequencies. These differences can result from different speaker elements being included in different speaker devices, or speaker devices having different qualities of speaker elements. For example, one speaker device may include a subwoofer for better reproduction of low frequencies, but another speaker device may have a high-quality tweeter for better reproduction of higher frequencies.

Frequency reproduction and audio quality is typically associated with volume or frequency gain, in that as the volume of a speaker device is increased, or the gain of a specific frequency or frequency band is increased, the quality of the audio output may be reduced. For example, the speakerphone 126 may be reasonably capable of reproducing low frequency sounds at lower volumes, but may vibrate or distort as the volume is increased, or if the gain of low frequencies is increased.

As noted in Example 1, disclosed techniques involve selectively attenuating frequencies at one speaker device, and increasing the gain of the frequencies at another speaker device in order to compensation for such attenuation. In the conference environment 100, in one embodiment, the speakerphone 126 is less capable of producing low frequencies, which can interact with its microphone, causing echo distortion. Accordingly, lower frequencies can be attenuated at the speakerphone 126, and the gain of these frequencies increased at the soundbar 122. Conversely, the soundbar 122 may be less capable of producing high frequency sounds, and the high frequencies can be attenuated at the soundbar, and the gain of the frequencies can be increased at the speakerphone 126.

In FIG. 1, it can be seen that the soundbar 122 is located at the front of the conference environment 100, by one head of the conference table 130, while the speakerphone 126 is located at the other end of the conference table. When low frequencies at the speakerphone 126 are attenuated, it may be beneficial to increase the gain at the soundbar 122 by a larger amount, so that the volume of the low frequencies for users at the end of the conference table 130 are similar to what would be experienced if the sound came from the speakerphone 126.

### Example 35)—Example Configuration of Speaker Devices

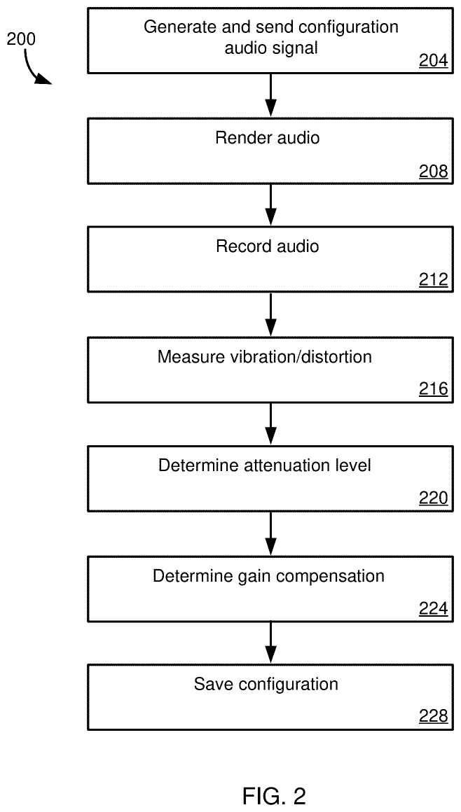

FIG. 2 provides a flowchart of a process 200 of determining frequency gain adjustment settings for one or more speaker devices. Generally, the process 200 involves providing a configuration signal to a speaker device, which then renders the audio signal. A microphone, such as an integrated microphone of the speaker device, captures the rendered audio signal, calculations are performed to determine performance information, such as the presence of vibrations or echo distortion, and compensatory settings are determined and stored for future use.

At 204, a configuration audio signal is generated and sent to a speaker device. In some implementations, audio processing performed during a teleconference is performed during rendering of the test signal. For example, echo compensation algorithms or other types of techniques to improve audio can be applied as the configuration signal is rendered, and the rendered sound captured for determining frequency gain adjustments.

The configuration signal can be implemented in a variety of ways. In one implementation, a sweeping signal is generated, such as signal that starts at a lower frequency and progresses to higher frequencies over time, or which starts at a higher frequency and progresses to lower frequencies over time. Since echo distortion is sensitive to gain/volume, the volume of the audio signal is typically selected to be appropriate given the nature of a listening environment in which the speaker device is being used or will be used. For example, a lower volume may be used if the speaker device is in a small room and a higher volume may be used if the speaker device is in a large room. However, audio configuration signals can also have variable volume, which can be used, for example, to store different configuration settings for different volume setting of the speaker device. In a similar manner, a starting set of bandwidth gains can be applied, which are typically selected to provide tonally balanced audio that facilitates speech intelligibility.

The configuration signal can be adjusted in terms of the number of frequencies scanned or the interval between frequencies. For example, the frequency scan can be incremented 1 Hz steps, 10 Hz steps, 100 Hz steps, etc. In some implementations, a single frequency, or a set of multiple frequencies, are generated in different frequency bands. In a simple example, the center frequency of a frequency band is used in the configuration signal. Although single frequencies have be discussed, an audio configuration signal can include multiple frequencies for a given audio signal “step”. As an example, if a low frequency band of 200 Hz-400 Hz is to be evaluated, the audio configuration signal may include a signal that includes frequencies between 250 Hz and 350 Hz for a period of time. Alternatively, one or more single frequencies can be used in the configuration audio signal, such as holding for 1 second periods a 200 Hz signal, a 300 Hz signal, and a 400 Hz signal.

The duration of a particular frequency in the configuration audio signal can also be adjusted, such as having each frequency in the frequency band be probed for 1 millisecond, 100 milliseconds, 1 second, or even longer durations.

The nature of the configuration audio signal can be selected based on a number of factors. For example, if low frequency performance is of primary concern, such as because of the potential for vibration, the configuration audio signal can be set to scan lower frequencies, and midrange or higher frequencies may not be generated. For the duration of any given frequency, the duration can be selected such that audio signal processing to evaluate system performance has sufficient data, or so that speaker device rendering artifacts, such as vibration or echo distortion, have time to manifest. That is, for example, vibration may become progressively worse at a given frequency the longer the frequency is being rendered.

In the field of audio testing and speaker characterization, generating appropriate test signals is important for evaluating the performance and behavior of speaker devices across different frequency ranges and operating conditions. While sinusoidal signals are commonly used for frequency sweeps and frequency response analysis due to their simple harmonic nature, alternative waveforms and mathematical functions can be employed to generate test signals for speaker devices.

For example, configuration signals can include waveforms such as square waves, triangle waves, and sawtooth waves. Square waves consist of alternating periods of high and low amplitude, triangle waves linearly ramp up and down between minimum and maximum amplitudes, and sawtooth waves ramp up linearly and reset to the minimum amplitude. These waveforms can provide different types of frequency variations and are useful for testing speaker devices' response to abrupt changes or continuous frequency sweeps.

As noted, sinusoidal signals can be used for frequency sweeps and frequency response analysis, and can be beneficial due to their simple harmonic nature. One signal that can be used is a chirp signal, also known as a linear frequency sweep or sine sweep. A chirp signal linearly sweeps through a range of frequencies over time. The chirp signal can be generated using the equation:

$$x ( t ) = A \cdot sin ( 2 π ( {f}_{0} + k t ) t )$$

where A is the amplitude, f₀ is the starting frequency, k is the sweep rate, and t is time. This approach allows for systematic evaluation of the speaker device's frequency response characteristics by sweeping through all frequencies between a starting frequency and a maximum frequency.

Alternatively, a non-chirp sinusoidal signal, representing a fixed-frequency sinusoid, can be generated, such as according to the equation:

$$x ( t ) = A \cdot sin ( 2 π {f}_{0} t + ϕ )$$

where A is the amplitude, f₀ is the frequency, ϕ is the phase offset, and t is time. This type of signal can be useful for generating specific frequencies, and some other function can be used to generate the sine wave at different frequencies.

Random signals such as band-limited noise and impulse signals, as well as step functions, can be employed for specific testing purposes. White noise contains equal power at all frequencies, which can be constrained to frequencies in a particular band, such as for low frequency testing. Impulse signals represent instantaneous pulses of infinite amplitude and infinitesimal duration, which can be used for testing transient response and impulse handling capabilities.

Rather than having a continuous frequency sweep, step functions can be used. Step functions abruptly change from one constant value to another at a specific time. An example of a step function can be represented as:

$$= \{ \begin{matrix}{f}_{1} if 0 \leq t < {t}_{1} \\ {f}_{2} if {t}_{1} \leq t < {t}_{1} \\ ⋮ \\ {f}_{n} if {t}_{n - 1} \leq t < {t}_{n}\end{matrix}$$

where x(t) is the output signal at time t, A and B are the initial and final amplitude values, respectively, and to is the time at which the step occurs.

$$x ( t )$$

In addition to the above-described waveform options, windowed sinusoids with frequency modulation can be used to generate audio configuration signals with varying shapes and characteristics. This involves modulating the frequency of a sinusoid over time using an envelope function, such as a Hann window, Hamming window, or Gaussian window. These window functions can be applied to the sinusoidal signal to create a composite waveform with specific amplitude and frequency characteristics. In that regard, disclosed techniques can use a fixed amplitude for each frequency or frequency set, or that amplitude can be varied. Varying the amplitude can help determine when audio performance is degraded, as vibration and distortion typically become more pronounced at the volume/gain increases.

For analysis/adjustment scenarios that involve generating multiple frequencies concurrently, a sum of sinusoids approach can be used. This involves summing multiple sinusoidal signals with different frequencies to create a composite signal containing multiple frequency components. The equation for a sum of sinusoids can be represented as:

$$x ( t ) = {\sum }_{i = 1}^{N} {A}_{i} sin ( 2 π {f}_{i} t + {ϕ}_{i} )$$

where x(t) is the output signal at time t, Aᵢ is the amplitude of the i-th sinusoid, fᵢ is the frequency of the i-th sinusoid, ϕᵢ is the phase of the i-th sinusoid, and N is the total number of sinusoids.

The audio configuration signal is provided to the speaker device and rendered by the speaker device at 208. It should be noted that operations 204 and 208 can be performed concurrently, that is, once the audio configuration signal is initiated, the audio can be rendered at the speaker device as the audio configuration signal continues to be generated and sent to the speaker device.

Audio produced by the speaker device in response to the audio configuration signal is captured at 212, such as by a microphone integrated into the speaker device. The captured audio is analyzed at 216, such as to measure vibration or distortion.

A variety of techniques can be used to characterize the performance of a speaker device. One technique is Echo-to-Signal Ratio (ESR). ESR involves isolating the echo energy at each frequency or frequency band. This entails applying frequency analysis techniques, such as Fourier transforms, to both the input (original) signal (the audio configuration signal) and the recorded output signal. By comparing the frequency-domain representations of these signals, the echo energy can be identified in the output signal. This comparison involves subtracting the frequency-domain representation of the input signal from that of the output signal, revealing the energy contributed by the echo. The ESR is then computed by comparing the energy of the isolated echo with that of the original signal at each frequency or frequency band. If desired, the ESR results can be plotted, which can facilitate understanding what frequencies are associated with high echo distortion.

Using the ESR results, software can determine whether particular frequencies or frequency bands exceed a threshold, such as if more than 10% distortion is observed.

Echo Delay can also be analyzed, which involves determining the time delay between the onset of the original signal and the onset of the echo at each frequency or frequency band. For the initial audio configuration signal and the recorded speaker output, time-domain analysis is performed on the recorded signal to identify the onset of the original signal and the onset of the echo at each frequency or frequency band. This analysis typically involves examining the temporal characteristics of the signal waveform, such as peak amplitudes or zero-crossings.

Once the onset of the original signal and the echo is identified, the time delay between these onsets for each frequency or frequency band is calculated. This involves determining the time difference between corresponding points in the original signal and the echoed signal. The calculated echo delay values are analyzed across the frequency spectrum to discern frequency-dependent variations in echo timing. The analysis can include plotting the echo delay values or performing statistical analysis to assess frequency-specific echo delay characteristics.

Statistical analysis can examine echo delay across different frequencies or frequency bands, providing information regarding the distribution and variability of echo delay values. Descriptive statistics are computed for the echo delay values and can be calculated at each frequency or frequency band. The descriptive statistics can include mean, median, standard deviation, and range. These statistics provide a summary of central tendency, variability, and spread for echo delay.

Another type of analysis can include frequency-specific variability, comparing measures of dispersion like standard deviation between frequency bands. Frequency distribution analysis can be used, which can include constructing histograms or density plots to visualize the distribution of echo delay values, assessing shape characteristics like skewness or kurtosis.

Outlier detection in echo delay values can also be useful, as they may indicate anomalous echo behavior. Techniques such as the interquartile range (IQR) or Z-score can help identify outliers beyond a certain threshold. Correlation analysis can identify potential relationships between echo delay values at different frequencies, investigating systematic associations.

Hypothesis testing can be performed, where this technique evaluates whether significant differences exist in echo delay values between frequency bands. Methods like analysis of variance (ANOVA) or non-parametric tests such as the Kruskal-Wallis test can assess these differences and determine their statistical significance.

Typically, longer echo delay values can be considered to be more problematic in terms of audio quality in a teleconference setting, as the echoes may be more pronounced. Further, echoes with longer delay can be more likely to contribute to comb filtering, where there can be multiple echoes for a given audio signal.

Echo decay rate can be used to assess echo distortion's impact on audio quality. Echo decay rate quantifies how rapidly echoes diminish after the original sound ceases. Time-domain analysis can be employed to assess the echo decay rate by analyzing the echo's amplitude envelope, which represents the variation of echo amplitude over time following the cessation of the original sound. By tracking the echo's amplitude decrease over time, the echo decay rate is determined, such as by fitting exponential decay functions to the echo signal and estimating relevant parameters like the decay time constant.

Frequency-domain analysis can also be used. Frequency domain analysis can apply Fourier transform techniques to the echo signal and examine decay characteristics across different frequency components.

Perceptually, rapid echo decay rates are preferred as they minimize echo persistence, enhancing audio clarity and intelligibility. Prolonged echo decay times, such as can occur at lower frequencies, can lead to perceptible reverberation and muddiness, impairing speech intelligibility and overall audio fidelity.

The frequency response of echos can be analyzed, where this measure evaluates how the amplitude and phase of echoes vary across different frequencies or frequency bands. Analyzing this aspect provides insights into how echo distortion affects specific frequency components of the audio signal.

Frequency analysis involves examining the spectral characteristics of the echo signal across the frequency spectrum. Techniques like Fourier transform decompose the echo signal into its frequency components, enabling analysis of their magnitudes and phases. In spectral analysis, a “good” frequency response typically exhibits minimal distortion or coloration across the frequency spectrum, with uniform amplification or attenuation of frequencies. Conversely, a “bad” frequency response may show irregularities such as peaks, dips, or non-linearities, indicating frequency-dependent distortion or tonal imbalance.

Impulse response analysis complements frequency analysis by measuring the echo's time-domain characteristics, offering insights into its decay behavior and transient response. This analysis involves convolving the echo's impulse response with a test signal, which serves as a known input for analysis purposes. Examples of test signals include white noise, sine sweeps, chirp signals, and pseudorandom binary sequences (PRBS). By convolving the echo's impulse response with the test signal, its frequency response can be deduced, providing further information about its spectral properties and potential distortion. This allows for an understanding of how the echo affects different frequency components of the input signal, and can be used to adjust frequency gain at the speaker device.

An audio signal captured at 212 can be analyzed using techniques other than echo distortion. For example, frequency response analysis evaluates how accurately a speaker device reproduces various frequencies across the audible spectrum. This process involves sending to the speaker device an audio configuration signal with known input signals covering a range of frequencies, such as the chirp signals or individual sine waves discussed earlier. The audio output produced by the speaker device in response to these input signals is then captured and analyzed to determine its frequency content and amplitude.

Unlike the technique described in the earlier discussion of echo distortion, which focuses on examining the spectral characteristics of a specific signal (echo), frequency response analysis evaluates the performance of the speaker system itself, assessing its ability to faithfully reproduce frequencies across the audible spectrum. Deviations from the ideal response are identified, indicating areas where the speaker system may exhibit irregularities or deficiencies in frequency reproduction. If certain frequencies exhibit such irregularities or deficiency, those frequencies can be selected for attenuation, with a corresponding gain increased at another speaker device.

Total Harmonic Distortion (THD) analysis assesses the extent to which a speaker device introduces harmonic distortion to the audio signal it produces. Harmonic distortion occurs when the speaker device generates additional frequencies that were not present in the original signal, typically multiples of the input frequencies known as harmonics. THD analysis involves sending the speaker device known input signals, such as sine waves or complex audio waveforms as described earlier for audio configural signals, and measuring the distortion present in the output signal. This distortion is quantified as a percentage of the total signal power, indicating the level of harmonic content relative to the original signal. Higher THD values suggest greater distortion and potential degradation of audio quality, which can be attenuated when the speaker device is in use to improve audio quality.

Rub and buzz analysis is a technique used to evaluate the mechanical performance of speaker systems, focusing on the presence of unwanted noises known as rubs and buzzes. Rubs occur when mechanical components within the speaker system come into contact, resulting in friction-induced sounds. Buzzes, on the other hand, are caused by resonant vibrations of components, producing an audible buzzing noise.

Rub and buzz analysis typically involves sending the speaker device a configuration audio signal, such as sine waves or broadband audio, while monitoring the output for any indications of rubs or buzzes. These unwanted noises can be quantified and analyzed to determine their frequency, intensity, and duration, providing insights into potential mechanical issues or deficiencies in the speaker design. Rub and buzz analysis can be used to identify frequencies that can be attenuated to improve audio quality.

Returning to the process 200, an attenuation factor is determined at 220 based on the audio analysis at 216. Generally, one or more criteria are defined for one or more of the audio quality measures discussed above. The criteria can determine when frequency gain adjustment is indicated, and can also be used to determine an adjustment amount.

In the case of frequency attenuation, an attention factor can be determined in a variety of ways. According to one example, a gain adjustment function can be defined where an input, such as a measure of echo distortion (and optionally other parameters, such as current volume or gain, or information about a frequency or frequency band associated with the input) is provided to the function and the function outputs a gain adjustment, which can be a specified amount (for example, in decibels) or a percent (for example, reducing the gain of the frequency or frequency band by 10% for a given input). A function can be determined by empirically determining how much gain reduction is needed to reduce echo distortion below a particular level.

Dynamic/adaptive techniques can also be used. For example, rather than having the speaker device render an audio configuration signal a single time, the gain of a frequency or frequency band can be adjusted after one set of measurements, the gain can be reduced, and then another set of measurements can be obtained. This process can continue until echo distortion (or another audio quality measure) is below a defined level.

At 224, a gain compensation can be determined. Gain compensation refers to increasing the gain of certain frequencies or frequency bands for one speaker device to compensate for the reduced gain of those frequencies or frequency bands for another speaker device. In a simple example, rules can be defined such that a certain level of gain attenuation at one speaker device is associated with a certain level of gain increase at another speaker device. These rules can take into account characteristics of the speaker devices, such as the relative output power of the speaker devices, the efficiencies of the speaker devices in converting electrical power into sound input, and the relative frequency response of the speaker devices—that is, some devices may be more efficient at generating some frequencies than other devices.

Equations can be defined to help determine what gain increase at one speaker device may be needed to compensate for a gain reduction at another speaker device. An example equation is:

$$Δ {G}_{2} = Δ {G}_{1} + ( {S}_{1} - {S}_{2} ) + 10 {log}_{10} ( \frac{{P}_{2}}{{P}_{1}} )$$

where ΔG₂ is the gain change at speaker whose gain is to be increased, S₁ and S₂ are the respective sensitivities of the two speakers, and P₁ and P₂ are the respective power levels of the speakers prior to any gain adjustment. In this case, sensitivity refers to the sound pressure, in perceived decibels, per Watt of input power at a distance of 1 meter, which is a fundamental characteristic of a given speaker device. Note that various terms, such as the sensitivity, can be modified to take into account the different frequency responses of different speaker devices. That is, sensitivity can be determined for a specific frequency or frequency band, since some speaker devices, for example, may be more efficient at producing low frequencies and others may be more efficient at producing higher frequencies.

In some embodiments, gain increase can be determined dynamically. For example, the amplitude of particular frequencies can be measured at a particular location prior to gain adjustment, as frequencies are attenuated at one speaker device, the gain of the frequencies can be instead at another speaker device, where the gain is increased so as to maintain the initially observed frequency amplitude.

The configuration information is stored at 228. Configuration information can be maintained at different levels of granularity. For example, configuration information can be maintained for single devices, such as storing gain attenuations at different frequencies or frequency bands, which can be correlated with a particular rendering volume. In other cases, attenuation can be determined for one or more devices of a particular type, and the configuration information can be associated with the device type.

Configuration information can also be maintained for pairs of device or device types. That is, improved teleconference audio can be achieved by determining gain increases for a specific device that are needed to compensate for frequency attenuation of another speaker device.

Configuration information can also be tied to a particular environment or environment type, such as a particular conference room or a particular size conference room. For example, gain compensation can be sensitive to room size, and from the distance between two speaker devices. Even if the same two devices are used together, the frequency compensation needed when the device are four feet apart can differ significantly from when the device are fifteen feet apart.

### Example 6)—Example Use of Speaker Device Configuration Information

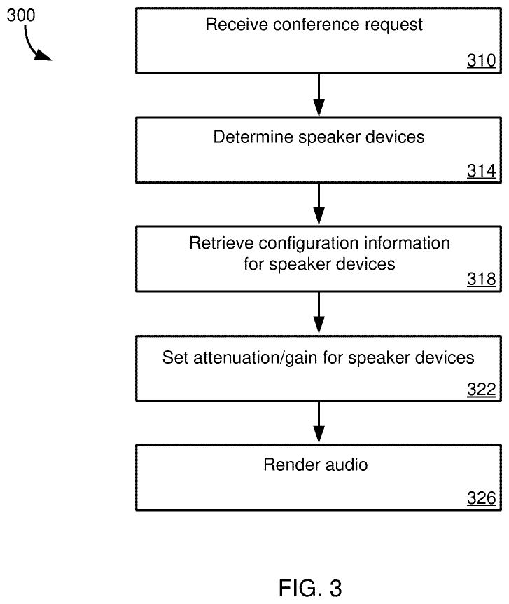

FIG. 3 illustrates a process 300 of using configuration information, such as determined in the process 200 of FIG. 2, in a teleconference. A teleconference request is received at 310. The teleconference request can be associated with a software application, where the request includes requests to use a plurality of speaker devices.

Audio devices associated with the conference request are determined at 314. For example, a particular teleconference application may store configurations with default audio devices to be used, which may be associated with a particular user profile or a profile for a specific conference environment, such as the conference environment 100 of FIG. 1. Alternatively, the request itself can specify speaker devices.

At 318, configuration information is retrieved for one or more of the speaker devices. At least one of the one or more speaker devices is associated with configuration information that attenuates one or more frequencies or frequency bands. The settings can be stored by a teleconference software application and retrieved, or can be set more generally, such as for audio settings for a computer operating system.

The attenuation or gain setting for the one or more speaker devices are set at 322. Setting the attenuation or gain settings can be accomplished in a variety of ways, such as accessing equalizer capabilities of a teleconferencing application or a computer operating system. In some cases, a teleconference system may have built in equalizer functionality, and that can be accessed to set frequency attenuation or gain for speaker devices.

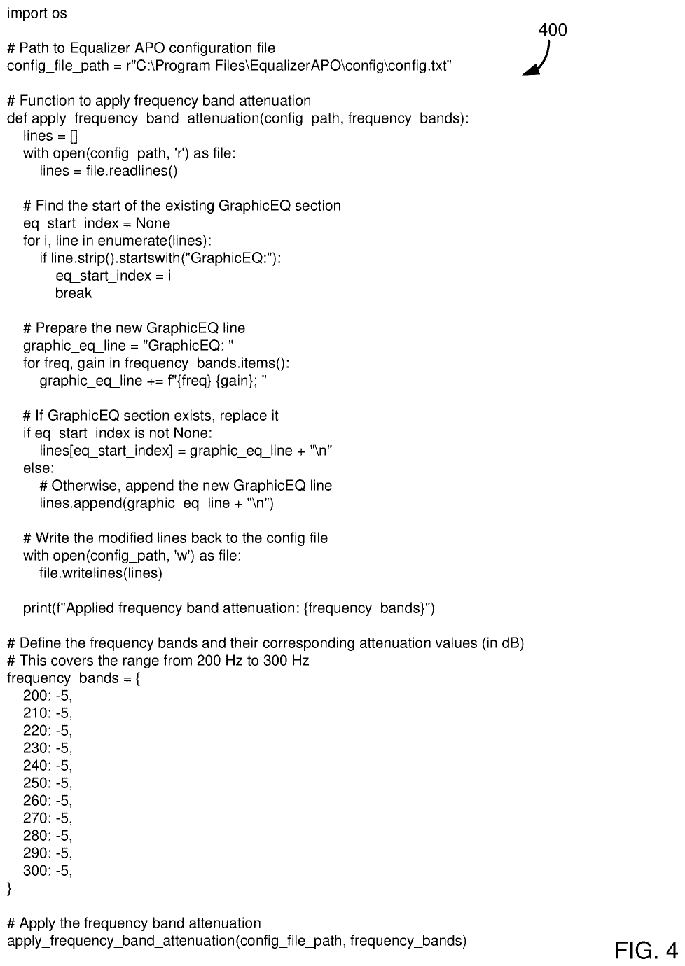

As one example, Equalizer APO is an open-source graphical equalizer for MICROSOFT WINDOWS. Equalizer APO can be used to adjust audio output setting. FIG. 4 provides an example python script for attenuating frequencies between 200-300 Hz by −5 dB, where this is accomplished by attenuating 10 Hz sub bands in that range.

Teleconference audio is rendered at 326 using the adjusted frequency gains.

### Example 7)—Example Frequency Adjustment of Multiple Speaker Devices

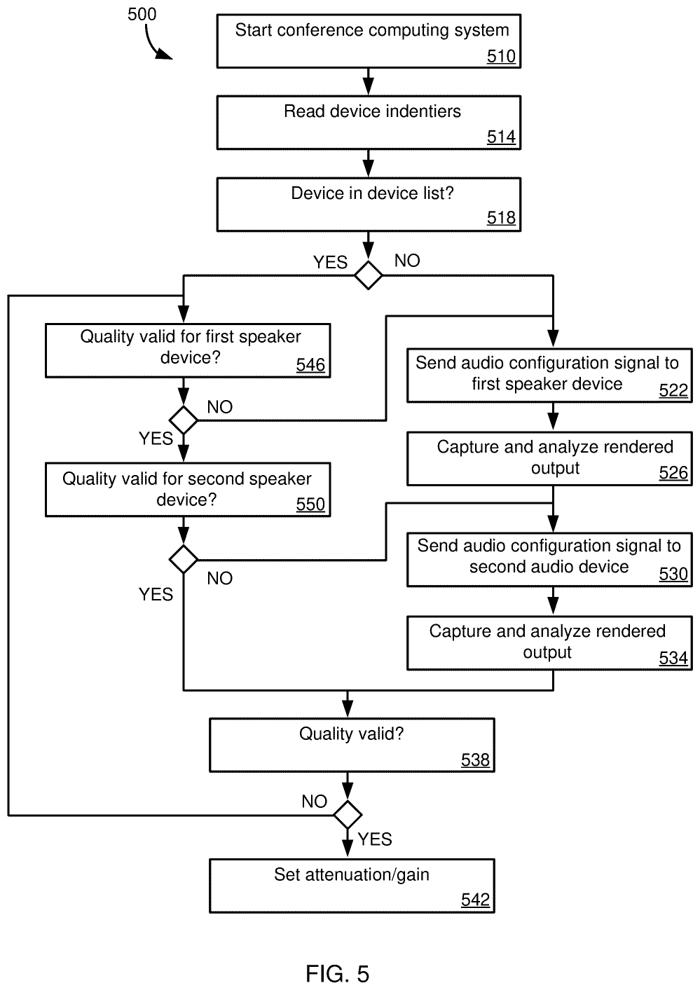

FIG. 5 is a flowchart of a process 500 of preparing a conference environment, such as the conference environment 100 of FIG. 1. It can be useful to perform the process 500 when the conference environment is initially set up, or if the speaker devices in the conference room (or, in some cases, their locations) have been changed. Since it may not be known whether a conference environment has been altered in a way that would detrimentally affect conference audio, the process 500 can be performed as part of an initialization of conference software.

A conference computing system is started at 510. Starting the conference computing system can refer to starting a computing system that is dedicated to performing conference functions, or to starting a conference computing application. One or more device identifiers for conference hardware configured for use with the conference computing system are detected at 514. For example, a conference device, which may or may not be a speaker device, may be connected to the conference computing system using an HDMI connection. An identifier of the conference device, along with other information, can be obtained, such as from Extended Display Identification Data (EDID) of the conference device.

At 518, it is determined whether the device identifier is in a device list accessible by the conference computing system. The device list contains configuration information for the conference computing system, such as information describing two or more speaker devices used for audio rendering by the conference computing system. For a device in the device list, the configuration information includes frequency attenuation or gain information associated with a previously described configuration process (such as the process 200 of FIG. 2). The configuration information can also store information about the audio quality of the speaker devices, such as measures of distortion or vibration present after frequency adjustment.

If it is determined at 518 that the device is not in the device list, a configuration process can be performed, such as the process 200 of FIG. 2. At 522, a configuration signal is sent to a first speaker device. The resulting audio is captured and analyzed at 526, and frequency attention/gain parameters are determined. Determining the frequency attenuation/gain parameters can include determining frequency attenuation parameters for the first speaker device and frequency gain parameters for another speaker device.

In a similar manner as for the first speaker device, an audio configuration signal is sent to a second speaker device at 530, and at 534 the rendered audio is captured, analyzed, and used to determine frequency attenuation/gain parameters. In some cases, certain frequencies are attenuated at the first speaker device and the gain increased for these frequencies at the second speaker device, and certain other frequencies are attenuated at the second speaker device and the gain for these other frequencies increased at the first speaker device. Although the process 500 has been described as performing frequency adjustment for two speaker devices, in other embodiments the configuration process is only carried out for one speaker device, but where this process can include increasing the gain for frequencies at another speaker device to compensate for frequency attenuation at the speaker device.

At 538, it is determined whether the audio quality for the first and second speaker devices is valid. That is, for example, conference application software may be associated with audio quality requirements, such as having an echo distortion below a threshold amount. If the audio quality is valid, the configuration settings (attenuation/gain) are set/saved at 542, which can include adding the conference device (such as an HDMI-connected device) along with the relevant configuration settings (which can thus also identify at least a portion of the speaker devices that are used along with the HDMI device).

If it is determined at 538 that the audio quality is not valid, the process 500 can continue to 546, where the process also continues if it is determined at 518 that the device is on the device list. At 546, it is determined whether an audio quality measure for the first speaker device is valid, such an amount of echo distortion previously determined for the first speaker device. If the quality level is not valid, the process proceeds to 522. Note that, in this case, after completing the operations at 526, the process 500 can proceed to another operation, rather than proceeding to 530.

If it was determined at 546 that the audio quality for the first speaker device was valid, or after performing the operation at 526 in response to the determination at 538, the process can proceed to 550, where it is determined whether audio quality of the second speaker device is valid, in a similar manner as determined for the first speaker device. If the audio quality is not valid, the process 500 can proceed to 522. If the audio quality for the second speaker device is determined not to satisfy the threshold, the process 500 proceeds to 530.

### Example 6—Example Technical Advantages

Disclosed techniques can provide a number of technical advantages. In particular, disclosed techniques provide improved quality for conference audio, by attenuating frequencies at a speaker device that might result in audio distortion or other types of quality degradation. Further, in some implementations, overall tonal quality can be maintained by, for another speaker device, increasing the gain of the attenuated frequencies.

The configuration process can be performed prior to teleconferences using the speaker device. This can provide clearer conference audio without a participant or organizer of the teleconference needing to take action. The disclosed techniques can be proactive, as compared to techniques where actions may be taken to improve audio quality after audio quality degradation has occurred.

### Example 7—Example Operations

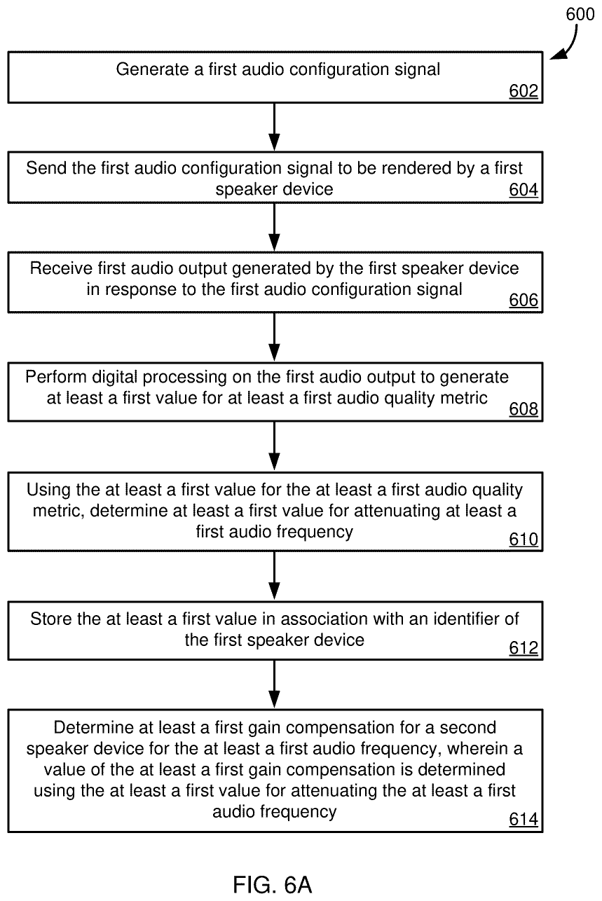

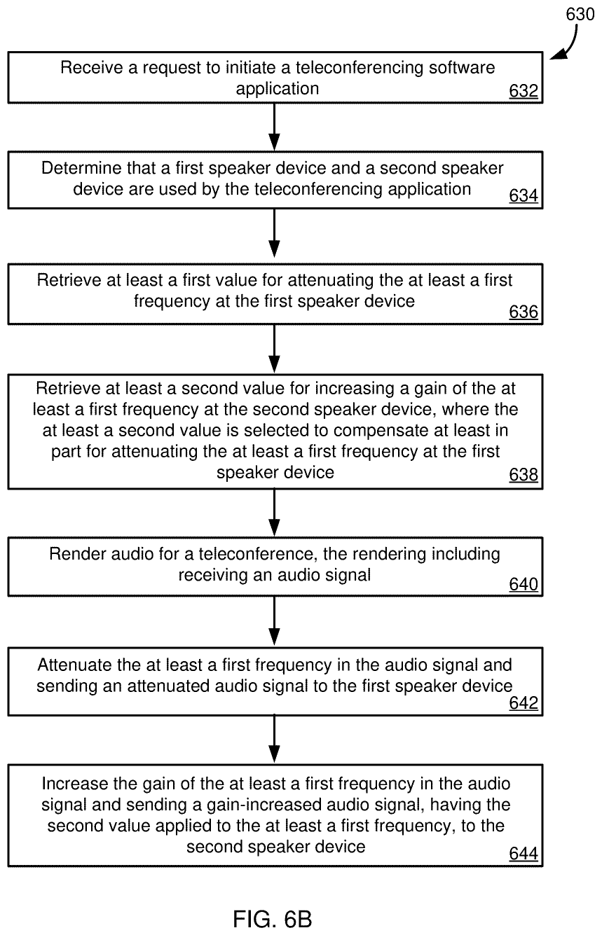

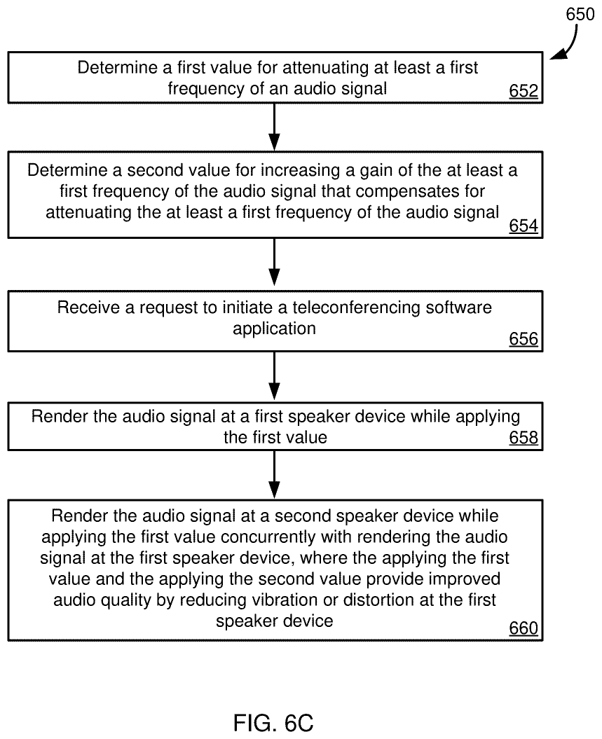

FIG. 6A is a flowchart of a process 600 for improving audio quality in a computing system. At 602, a first audio configuration signal is generated. At 604, the first audio configuration signal is sent to be rendered by a first speaker device. First audio output generated by the first speaker device in response to the first audio configuration signal is received at 606. At 608, digital processing is performed on the first audio output to generate at least a first value for at least a first audio quality metric. Using the at least a first value for the at least a first audio quality metric, at 610, at least a first value for attenuating at least a first audio frequency is determined. The at least a first value is stored at 612 in association with an identifier of the first speaker device. At 614, at least a first gain compensation is determined for a second speaker device for the at least a first audio frequency, where a value of the at least a first gain compensation is determined using the at least a first value for attenuating the at least a first audio frequency.

FIG. 6B illustrates a process 630 for improving audio quality during audio rendering using frequency attenuation and frequency gain increase values for first and second speaker devices. The process begins at 632 with the receipt of a request to initiate a teleconferencing software application. Determination of the usage of a first speaker device and a second speaker device by the teleconferencing application occurs at 634. Retrieval of at least a first value for attenuating the at least a first frequency at the first speaker device is performed at 636.

At 638, the system retrieves at least a second value for increasing a gain of the at least a first frequency at the second speaker device, where the at least a second value compensates at least in part for attenuating the at least a first frequency at the first speaker device. Audio for a teleconference is rendered at 640, which includes receiving an audio signal. The at least a first frequency in the audio signal is attenuated and an attenuated audio signal is sent to the first speaker device at 642. Finally, at 644, the gain of the at least a first frequency in the audio signal is increased and a gain-increased audio signal, having the second value applied to the at least a first frequency, is sent to the second speaker device.

FIG. 6C illustrates a process 650 for improving audio quality by determining frequency attenuation and frequency gain increase values for first and second speaker devices that are applied to audio during a teleconference. A first value for attenuating at least a first frequency of an audio signal is determined at 652. At 654, a second value for increasing a gain of the at least a first frequency of the audio signal is determined that compensates for attenuating the at least a first frequency of the audio signal. A request to initiate a teleconferencing software application is received at 656. At 658, the audio signal is rendered at a first speaker device while applying the first value. At 660, the audio signal is rendered at a second speaker device while applying the first value concurrently with rendering the audio signal at the first speaker device. This application of the first value and the second value provides improved audio quality by reducing vibration or distortion at the first speaker device.

### Example 8—Additional Examples

Example 1 provides a computing system that includes at least one memory and at least one hardware processor coupled to the memory. The system also includes one or more computer-readable storage media storing computer-executable instructions. When executed, these instructions cause the computing system to perform audio configuration operations that improve audio quality. These operations include generating a first audio configuration signal, sending this signal to be rendered by a first speaker device, and receiving the first audio output generated by the first speaker device in response to the signal. The system performs digital processing on the first audio output to generate at least a first value for at least a first audio quality metric. Using this value, the system determines at least a first value for attenuating at least a first audio frequency. This value is stored in association with an identifier of the first speaker device. The system also determines at least a first gain compensation for a second speaker device for the first audio frequency, where the value of the gain compensation is determined using the first value for attenuating the first audio frequency.

Example 2 extends Example 1, where the first audio output is recorded by a first microphone of the first speaker device.

Example 3 extends Example 1 or Example 2, where the first audio configuration signal generates at least one frequency within each of multiple frequency bands.

Example 4 extends Example 3, where the multiple frequency bands comprise a low frequency band, a middle frequency band, and a high frequency band.

Example 5 extends any of Examples 1-4, where the first audio frequency is within the range of 20 Hz to 250 Hz.

Example 6 extends any of Examples 1-5, where the first quality metric characterizes mechanical vibration in the first speaker device.

Example 7 extends any of Examples 1-6, where the operations further include receiving a request to initiate a teleconferencing software application, determining that the first speaker device and the second speaker device are used by the teleconferencing application, retrieving the first value for attenuating the first frequency and the value of the first gain compensation, rendering audio for a teleconference, attenuating the first frequency in the audio signal and sending an attenuated audio signal to the first speaker device, and increasing the gain of the first frequency in the audio signal and sending a gain-increased audio signal, having the first gain compensation value applied to the first frequency, to the second speaker device.

Example 8 extends any of Examples 1-5 or 7, where the quality metric characterizes echo distortion in the first speaker device.

Example 9 extends any of Examples 1-8, where the audio configuration signal comprises a step sweep signal or a chirp signal.

Example 10 extends any of Examples 1-9, where the second speaker device reproduces low frequency sounds with less distortion than the first speaker device for the same sound pressure level.

Example 11 extends any of Examples 1-10, where the operations further include generating a second audio configuration signal, sending the second audio configuration signal to be rendered by the second speaker device, receiving second audio output generated by the second speaker device in response to the second audio configuration signal, performing digital processing on the second audio output to generate at least a second value for at least a second audio quality metric, using the second value for the second quality metric, determining at least a second value for attenuating the second audio frequency, storing the second value in association with an identifier of the second speaker device, and determining at least a second gain compensation for the first speaker device for the second audio frequency, where the value of the second gain compensation is determined using the second value for attenuating the second audio frequency.

Example 12 extends any of Examples 1-11, where the operations further include applying echo compensation to the first audio output after receiving it to provide first echo-compensated audio output, where the digital processing is performed on the first echo-compensated audio output.

Example 13 illustrates a method of improving audio quality, implemented in a computing system. This method involves receiving a request to initiate a teleconferencing software application, determining that a first speaker device and a second speaker device are used by the teleconferencing application, retrieving a first value for attenuating a first frequency at the first speaker device, and retrieving a second value for increasing a gain of the first frequency at the second speaker device. The method also includes rendering audio for a teleconference, attenuating the first frequency in the audio signal and sending an attenuated audio signal to the first speaker device, and increasing the gain of the first frequency in the audio signal and sending a gain-increased audio signal to the second speaker device.

Example 14 extends Example 13, where the second speaker device reproduces low frequency sounds with less distortion than the first speaker device for the same sound pressure level.

Example 15 extends Example 13 or Example 14, where the method further includes determining the first value and the second value by generating a first audio configuration signal, sending the signal to be rendered by the first speaker device, receiving first audio output generated by the first speaker device in response to the signal, performing digital processing on the first audio output to generate a first value for a first audio quality metric, using the first value for the first audio quality metric to determine a first value for attenuating a first audio frequency, storing the first value in association with an identifier of the first speaker device, and determining the second value using the first value for attenuating the first audio frequency.

Example 16 extends any of Examples 13-15, where the first quality metric characterizes mechanical vibration in the first speaker device.

Example 17 provides one or more computer-readable storage media comprising computer-executable instructions. When executed by a computing system, these instructions cause the system to determine a first value for attenuating a first frequency of an audio signal, determine a second value for increasing a gain of the first frequency of the audio signal, receive a request to initiate a teleconferencing software application, render the audio signal at a first speaker device while applying the first value, and render the audio signal at a second speaker device while applying the first value concurrently with rendering the audio signal at the first speaker device.

Example 18 extends Example 17, where the computer-readable storage media further includes instructions that, when executed by the computing system, cause the system to receive first audio output generated by the first speaker device in response to a first audio configuration signal, perform digital processing on the first audio output to generate a first value for a first audio quality metric, and determine the first value using the first value for the first audio quality metric.

Example 19 extends Example 17 or Example 18, where the first audio quality metric measures distortion in the first audio output signal.

Example 20 extends any of Examples 17-19, where the second value is calculated using the first value.

### Example 9—Computing Systems

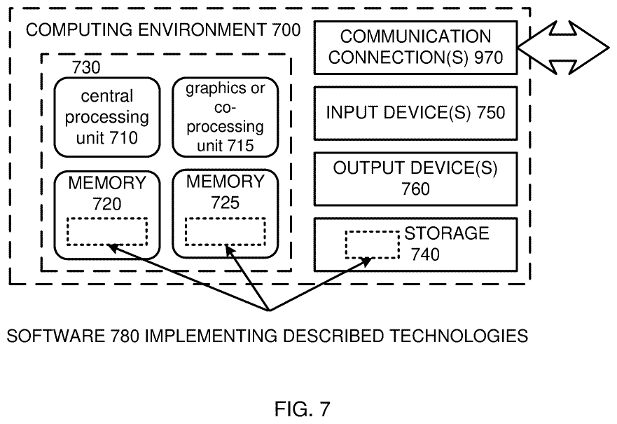

FIG. 7 depicts a generalized example of a suitable computing system 700 in which the described innovations may be implemented. The computing system 700 is not intended to suggest any limitation as to scope of use or functionality of the present disclosure, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions, such as for implementing the features described in Examples 1-8. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s) 710, 715. The memory 720, 725 stores software 780 implementing one or more innovations described herein, in the form of computer-executable instructions suitable for execution by the processing unit(s) 710, 715.

A computing system 700 may have additional features. For example, the computing system 700 includes storage 740, one or more input devices 750, one or more output devices 760, and one or more communication connections 770, including input devices, output devices, and communication connections for interacting with a user. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information in a non-transitory way, and which can be accessed within the computing system 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 10—Cloud Computing Environment

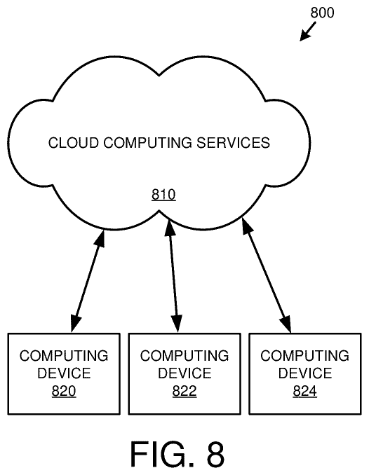

FIG. 8 depicts an example cloud computing environment 800 in which the described technologies can be implemented. The cloud computing environment 800 comprises cloud computing services 810. The cloud computing services 810 can comprise various types of cloud computing resources, such as computer servers, data storage repositories, networking resources, etc. The cloud computing services 810 can be centrally located (e.g., provided by a data center of a business or organization) or distributed (e.g., provided by various computing resources located at different locations, such as different data centers and/or located in different cities or countries).

The cloud computing services 810 are utilized by various types of computing devices (e.g., client computing devices), such as computing devices 820, 822, and 824. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operations (e.g., data processing, data storage, and the like).

### Example 11—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections (e.g., 770).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
at least one hardware processor coupled to the at least one memory; and
one or more computer readable storage media storing computer-executable instructions, that, when executed, cause the computing system to perform audio configuration operations that improve audio quality, the audio configuration operations comprising:
generating a first audio configuration signal;
sending the first audio configuration signal to be rendered by a first speaker device;
receiving first audio output generated by the first speaker device in response to the first audio configuration signal;
performing digital processing on the first audio output to generate at least a first value for at least a first audio quality metric;
using the at least a first value for the at least a first audio quality metric, determining at least a first value for attenuating at least a first audio frequency;
storing the at least a first value in association with an identifier of the first speaker device; and
determining at least a first gain compensation for a second speaker device for the at least a first audio frequency, wherein a value of the at least a first gain compensation is determined using the at least a first value for attenuating the at least a first audio frequency.

2. The computing system of claim 1, wherein the first audio output is recorded by a first microphone of the first speaker device.

3. The computing system of claim 1, wherein the first audio configuration signal generates at least one frequency within each of multiple frequency bands.

4. The computing system of claim 3, wherein the multiple frequency bands comprise a low frequency band, a middle frequency band, and a high frequency band.

5. The computing system of claim 1, wherein the at least a first audio frequency is within a range of 20 Hz to 250 Hz.

6. The computing system of claim 1, wherein the at least a first audio quality metric characterizes mechanical vibration in the first speaker device.

7. The computing system of claim 1, the operations further comprising:
receiving a request to initiate a teleconferencing software application;
determining that the first speaker device and the second speaker device are used by the teleconferencing software application;
retrieving the at least a first value for attenuating the at least a first frequency and the value of the at least a first gain compensation;
rendering audio for a teleconference, the rendering comprising receiving an audio signal;
attenuating the at least a first audio frequency in the audio signal and sending an attenuated audio signal to the first speaker device; and
increasing a gain of the at least a first audio frequency in the audio signal and sending a gain-increased audio signal, having the at least a first gain compensation value applied to the at least a first audio frequency, to the second speaker device.

8. The computing system of claim 1, wherein the at least a first quality metric characterizes echo distortion in the first speaker device.

9. The computing system of claim 1, wherein the first audio configuration signal comprises a step sweep signal or a chirp signal.

10. The computing system of claim 1, wherein the second speaker device reproduces low frequency sounds with less distortion than the first speaker device for a same sound pressure level.

11. The computing system of claim 1, the operations further comprising:
generating a second audio configuration signal, where the second audio configuration signal is the first audio configuration signal or is different than the first audio configuration signal;
sending the second audio configuration signal to be rendered by the second speaker device;
receiving second audio output generated by the second speaker device in response to the second audio configuration signal;
performing digital processing on the second audio output to generate at least a second value for at least a second audio quality metric, wherein the at least a second audio quality metric is the at least a first audio quality metric or is an audio quality metric different than the at least a first audio quality metric;
using the at least a second value for the at least a second audio quality metric, determining at least a second value for attenuating at least a second audio frequency;
storing the at least a second value in association with an identifier of the second speaker device; and
determining at least a second gain compensation for the first speaker device for the at least a second audio frequency, where a value of the at least a second gain compensation is determined using the at least a second value for attenuating the at least a second audio frequency.

12. The computing system of claim 1, the operations further comprising:
after receiving the first audio output, applying echo compensation to the first audio output to provide first echo-compensated audio output, wherein the digital processing is performed on the first echo-compensated audio output.

13. A method of improving audio quality, implemented in a computing system comprising at least one memory and at least one hardware processor coupled to the at least one memory, the method comprising:
receiving a request to initiate a teleconferencing software application;
determining that a first speaker device and a second speaker device are used by the teleconferencing software application;
retrieving at least a first value for attenuating at least a first frequency at the first speaker device;
retrieving at least a second value for increasing a gain of the at least a first frequency at the second speaker device, wherein the at least a second value is selected to compensate at least in part for attenuating the at least a first frequency at the first speaker device;
rendering audio for a teleconference, the rendering comprising receiving an audio signal;
attenuating the at least a first frequency in the audio signal and sending an attenuated audio signal to the first speaker device; and
increasing the gain of the at least a first frequency in the audio signal and sending a gain-increased audio signal, having the at least a second value applied to the at least a first frequency, to the second speaker device.

14. The method of claim 13, wherein the second speaker device reproduces low frequency sounds with less distortion than the first speaker device for a same sound pressure level.

15. The method of claim 13, further comprising determining the at least a first value and the at least a second value by:
generating a first audio configuration signal;
sending the first audio configuration signal to be rendered by the first speaker device;
receiving first audio output generated by the first speaker device in response to the first audio configuration signal;
performing digital processing on the first audio output to generate at least a first value for at least a first audio quality metric;
using the at least a first value for the at least a first audio quality metric, determining the least a first value for attenuating at least a first audio frequency;
storing the at least a first value in association with an identifier of the first speaker device; and
determining the at least a second value, wherein the at least a second value is determined using the at least a first value for attenuating the at least a first audio frequency.

16. The method of claim 13, wherein the at least a first audio quality metric characterizes mechanical vibration in the first speaker device.

17. One or more computer-readable storage media comprising:
computer-executable instruction that, when executed by a computing system comprising at least one hardware processor and at least one memory coupled to the at least one hardware processor, cause the computing system to determine a first value for attenuating at least a first frequency of an audio signal;
computer-executable instruction that, when executed by the computing system, cause the computing system to determine a second value for increasing a gain of the at least a first frequency of the audio signal that compensates for attenuating the at least a first frequency of the audio signal;
computer-executable instruction that, when executed by the computing system, cause the computing system to receive a request to initiate a teleconferencing software application;
computer-executable instruction that, when executed by the computing system, cause the computing system to render the audio signal at a first speaker device while applying the first value; and
computer-executable instruction that, when executed by the computing system, cause the computing system to render the audio signal at a second speaker device while applying the first value concurrently with rendering the audio signal at the first speaker device, whereby the applying the first value and the applying the second value provide improved audio quality by reducing vibration or distortion at the first speaker device.

18. The one or more computer-readable storage media of claim 17, further comprising:
computer-executable instruction that, when executed by the computing system, cause the computing system to receive first audio output generated by the first speaker device in response to a first audio configuration signal;
computer-executable instruction that, when executed by the computing system, cause the computing system to perform digital processing on the first audio output to generate at least a first value for at least a first audio quality metric; and
computer-executable instruction that, when executed by the computing system, cause the computing system to, using the at least a first value for the at least a first audio quality metric, determine the first value.

19. The one or more computer-readable storage media of claim 18, wherein the first audio quality metric measures distortion in the first audio output.

20. The one or more computer-readable storage media of claim 17, wherein the second value is calculated using the first value.
